(19) United States
(12) Patent Application Publication
(10) Pub. No.: US 2009/0007363 A1
(43) Pub. Date: Jan. 8, 2009

(54) Windscreen Wiper Device

(75) Inventor: Armin Stubner, Buehl-Altschweier (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/159,047

(22) PCT Filed: Nov. 15, 2006
(86) PCT No.: PCT/EP06/68502

§ 371 Date: Jun. 24, 2008

(30) Foreign Application Priority Data
Dec. 28, 2005 (DE) 102005062696.3

(51) Int. Cl. B60S 1/30

(52) U.S. Cl. 15/250.31

(57) ABSTRACT

The invention relates to a windscreen wiper device, in particular for a motor vehicle, comprising at least one shaft (13) that is mounted in a gear housing. The windscreen wiper devices that are known from prior art have gear housings that require a large amount of space. To provide a smaller gear housing, one end of the shaft or shafts (13) can be mounted in the gear housing (11) and the other end in a gear housing cover (12).

### BACKGROUND OF THE INVENTION

The invention relates to a windscreen wiper device, in particular for a motor vehicle, comprising at least one shaft mounted in a gear housing.

In the windscreen wiper devices known from the prior art, the at least one shaft is mounted with two shorter bearing bushes or one long bearing bush in the gear housing. As this mounting of the at least one shaft requires a relatively large amount of space, the gear housing previously required a relatively large installation space.

### SUMMARY OF THE INVENTION

The object of the invention is to improve a windscreen wiper device of the aforementioned type such that, in the future, the gear housing may be of smaller construction.

The invention solves the problem set forth with a windscreen wiper device of the aforementioned type, in which according to the invention the at least one shaft may be mounted at one end in the gear housing and at the other end in a gear housing cover. As a result of this simple constructional measure, in future the gear housing is able to be of markedly smaller construction than before. With the windscreen wiper device according to the invention, the at least one shaft may be mounted on one side in a bearing bush arranged in the gear housing during assembly, for lubricating teeth or for adjusting gear clearance. Thus, even when the gear cover has not yet been installed, sufficiently high forces and moments may be absorbed by the bearing bush arranged in the gear housing.

When the at least one shaft is an output shaft, the advantages according to the invention become particularly apparent as particularly high forces and moments act on the output shaft.

The position of the at least one shaft may be adjusted by means of at least one bearing bush arranged in the gear housing. In this manner, the distance of the at least one shaft, for example from a gearing worm, may be accurately adjusted, in order to ensure optimal running characteristics of the gear.

In order to be able to adjust optimally the position of the at least one shaft, the at least one bearing bush may comprise an eccentrically arranged bore. So that the distance between the at least one shaft and the gearing worm may be accurately adjusted, the bearing bush may accordingly be positioned in a bore receiving said bearing bush. When the distance between the at least one shaft and the bearing bush is large, the bearing bush is positioned in the bore receiving said bearing bush, such that the bore in the bearing bush is at as short a distance as possible from the gearing worm. When, however, the distance between the at least one shaft and the gearing worm is short, the bearing bush is positioned in the bore receiving said bearing bush such that the bore in the bearing bush is at as great a distance as possible from the gearing worm.

As the bearing bush comprising the eccentric bore has to be very accurately positioned in the gear housing and/or in the gear housing cover, in order to be able to adjust accurately the distance between the at least one shaft and the gearing worm, the bearing bush may also be able to be fitted positively into the gear housing and/or into the gear housing cover. Thus a bore provided in the gear housing and/or in the gear housing cover for receiving the bearing bush may have a flattened portion on one side, in a similar manner to the bearing bush to be fitted.

The at least one bearing bush comprising the eccentric bore may be manufactured with different eccentricities. As a result, a fitter may select the most suitable bearing bush from a plurality of bearing bushes with eccentric bores, when optimally adjusting the at least one shaft.

In order additionally to be able to reduce the dimensions of the gear housing, the at least one shaft may be able to be mounted in two short bearing bushes, the one bearing bush being able to be arranged in the gear housing and the other bearing bush being able to be arranged in the gear housing cover.

So that the gear has as long a service life as possible, the bearing bushes may be made from a particularly slidable material.

The windscreen wiper device may be produced very cost-effectively when the gear cover is made from sheet metal.

### BRIEF DESCRIPTION OF THE DRAWINGS

Various embodiments are described in more detail hereinafter with reference to the accompanying drawings, in which in detail:

FIG. 1 shows a sectional view through a first embodiment of a gear;

FIG. 2 shows a plan view of a second embodiment of the gear;

FIG. 3 shows a plan view of a third embodiment of the gear.

### DETAILED SUMMARY

FIG. 1 shows a gear 10 comprising a gear housing 11 and a gear housing cover 12. A shaft 13 of a gear wheel 14 is mounted in bearing bushes 15 and 16, the bearing bush 15 being arranged in the gear housing 11 and the bearing bush 16 in the gear housing cover 12. By the arrangement of the bearing bush 15 and 16 in the gear housing 11 and in the gear housing cover 12, the gear 10 may be of very low profile construction.

The bearing bush 15 may support the shaft 13 on one side during assembly. Thus, during assembly, for lubricating teeth of the gear wheel 14 or for adjusting gear clearance between the gear wheel 14 and a gearing worm 17, when the gear housing cover 12 is not yet installed, the bearing bush 15 may absorb the active forces and moments which act during these processes on the bearing bush 15.

In order to be able to construct the gear 10 to be as low-profiled as possible, the bearing bushes 15 and 16 are designed to be as short as possible.

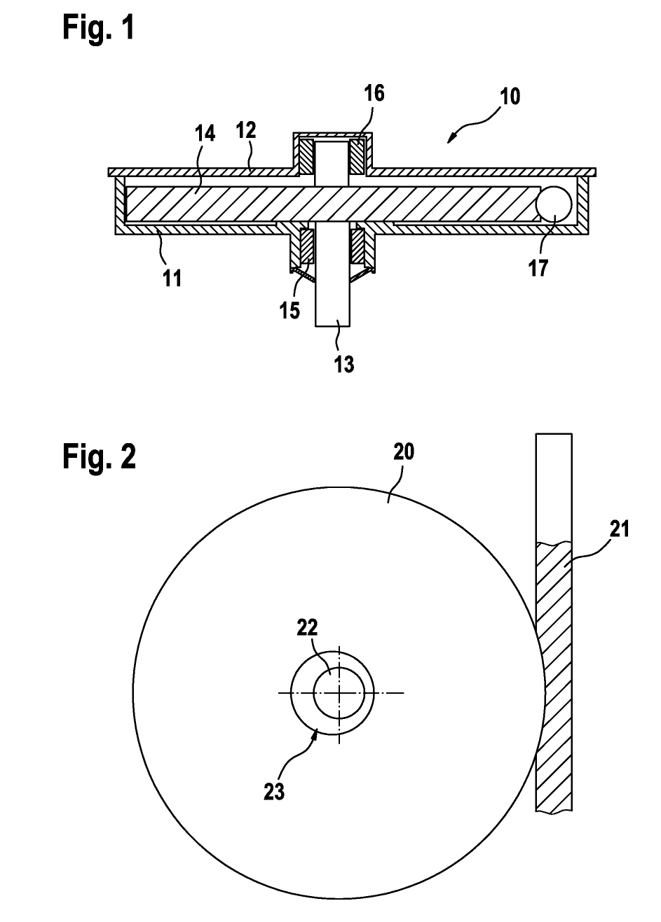

FIG. 2 shows a gear wheel 20 which engages in a gearing worm 21. For a maximum engagement of the gear wheel 20 in the gearing worm 21, with simultaneous minimum wear of the gear wheel 20 and the gearing worm 21, it is important to adjust the distance between a shaft 22 and the gearing worm 21 in an optimal manner. To this end, a bearing bush 23 may have an eccentrically arranged bore which receives the shaft 22. When the distance between the shaft 22 and the gearing worm 21 is large, the bearing bush 23 is positioned such that the bore receiving the shaft 22 is at as short a distance as possible from the gearing worm 21. When, however, the distance between the shaft 22 and the gearing worm 21 is short, the bearing bush 23 then has to be positioned such that the bore receiving the shaft 22 is at a large distance from the gearing worm 21.

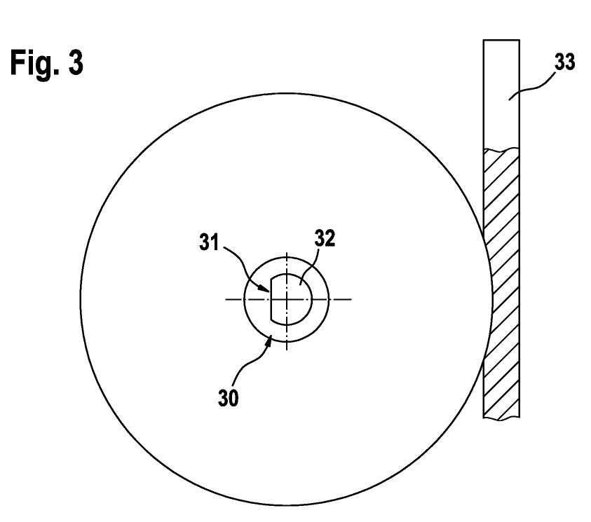

In order to be able to adjust the distance between a shaft 32 and a gearing worm 33 in an optimal manner, it may also be helpful when different bearing bushes with different eccentricities (see FIG. 3) are available to the fitter, as an alternative.

The bearing bush 30 shown in FIG. 3 has a flattened portion 31 on one side. A bore provided in the gear housing or in the gear housing cover for receiving the bearing bush 30 also has a flattened portion adapted to the flattened portion 31. Thus the bearing bush 30 may be positively fitted into the gear housing or into the gear housing cover. Due to the positive connection between the bearing bush 30 and the bore receiving the bearing bush 30, the bearing bush 30 may be very accurately fitted into the gear housing and into the gear housing cover, in order to be able to adjust the distance between a shaft 32 and a gearing worm 33 in an optimal manner.

The bearing bush 23 comprising the bore arranged eccentrically may be provided both in the gear housing and in the gear housing cover.

1. A windscreen wiper device, comprising at least one shaft (13, 22, 32) mounted in a gear housing, characterized in that the at least one shaft (13, 22, 32) is mounted at one end in the gear housing (11) and at an other end in a gear housing cover (12).

2. The windscreen wiper device as claimed in claim 1, characterized in that the at least one shaft (13, 22, 32) is an output shaft.

3. The windscreen wiper device as claimed in claim 1, characterized in that position of the at least one shaft (13, 22, 32) may be adjusted by means of at least one bearing bush (15, 23, 30) arranged in the gear housing (11).

4. The windscreen wiper device as claimed in claim 3, characterized in that the at least one bearing bush (23, 30) comprises an eccentric bore.

5. The windscreen wiper device as claimed in claim 1, characterized in that the at least one shaft (13, 22, 32) is mounted in two short bearing bushes (15, 16), one bearing bush (15) being arranged in the gear housing (14) and the other bearing bush (16) being arranged in the gear housing cover (12).

6. The windscreen wiper device as claimed in claim 1, characterized in that the bearing bushes (15, 16, 23, 30) are made from a particularly slidable material.

7. The windscreen wiper device as claimed in claim 1, characterized in that the gear cover (12) is made from sheet metal.

8. The windscreen wiper device as claimed in claim 2, characterized in that position of the at least one shaft (13, 22, 32) may be adjusted by means of at least one bearing bush (15, 23, 30) arranged in the gear housing (11).

9. The windscreen wiper device as claimed in claim 8, characterized in that the at least one bearing bush (23, 30) comprises an eccentric bore.

10. The windscreen wiper device as claimed in claim 9, characterized in that the at least one shaft (13, 22, 32) is mounted in two short bearing bushes (15, 16), one bearing bush (15) being arranged in the gear housing (14) and the other bearing bush (16) being arranged in the gear housing cover (12).

11. The windscreen wiper device as claimed in claim 10, characterized in that the bearing bushes (15, 16, 23, 30) are made from a particularly slidable material.

12. The windscreen wiper device as claimed in claim 11, characterized in that the gear cover (12) is made from sheet metal.
